(19) United States
(12) Patent Application Publication
(10) Pub. No.: US 2023/0257304 A1
(43) Pub. Date: Aug. 17, 2023

(54) Modification of Asphalt Oxidation and Binders with Polymers

(71) Applicant: GreenMantra Recycling Technologies Ltd., Brantford (CA)

(72) Inventors: Domenic Di Mondo, Brampton (CA); John Almey, Burlington (CA)

(21) Appl. No.: 18/305,967

(22) Filed: Apr. 24, 2023

Related U.S. Application Data
(63) Continuation of application No. 17/085,948, filed on Oct. 30, 2020, now abandoned.
Application No. 17/085,948 is a continuation of application No. PCT/CA2019/050762, filed on May 9, 2019.
(60) Provisional application No. 62/679,150, filed on Jun. 1, 2018.
(60) Provisional application No. 62/681,344, filed on Jun. 6, 2018.

(51) Int. Cl. C04B 26/26; C04B 18/22; C04B 24/26

(52) U.S. Cl. CPC C04B 26/26; C04B 18/22; C04B 24/2611

(57) ABSTRACT

Asphalt can be modified by polymers, oligomers, and waxes made from polymeric material. The addition of polymer, oligomer, or wax can increase the softening point of the asphalt, decrease the penetration of the asphalt, and/or shorten the oxidation of the asphalt. In some embodiments, polymer, oligomer, or wax is added to an oxidized asphalt. The polymer, oligomer, or wax can be made by catalytic depolymerization and/or thermal degradation of polymeric material. The polymeric material can be polystyrene, polypropylene, polyethylene, a combination of polypropylene and polyethylene or recycled plastics. In some embodiments, addition of the polymer, oligomer, or wax improves the performance grade of a paving asphalt binder alone or in combination with other modifiers such as ground tire rubber and polymers. The addition of wax can increase the high service temperature of the asphalt binder.

### CROSS-REFERENCE TO RELATED APPLICATIONS

This application is a continuation of U.S. Application No. 17/085,948 having a filing date of Oct. 30, 2020, entitled “Modification of Asphalt Oxidation and Binders with Polymers”. The ‘948 application is a continuation of International Application No. PCT/CA2019/050762 having an international filing date of May 9, 2019, entitled “Modification of Asphalt Oxidation and Binders with Polymers”. The ‘762 application is related to and claims priority benefits from U.S. Provisional Application Serial No. 62/679,150 filed on Jun. 1, 2018, entitled “Modification of Asphalt Oxidation with Waxes Derived from Depolymerization of Plastic”. The ‘762 application is also related to and claims priority benefits from U.S. Provisional Application Serial No. 62/681,344 filed on Jun. 6, 2018, entitled “Modification of Asphalt Binders with Waxes to Improve Performance Grade”.

The present application claims priority to the ‘948, ‘762, ‘150 and ‘344 applications which are hereby incorporated by reference herein in their entireties.

### FIELD OF THE INVENTION

The present invention relates to a method of employing polymers, oligomers, and waxes, from now on just referred to as waxes, as additives in asphalt formulations. In some embodiments, the waxes are created via the depolymerization of polymers. In some embodiments, the addition of the wax(es) improve(s) asphalt properties including increasing the softening point and/or hardness of the asphalt. In some embodiments, the addition of the wax(es) to asphalt binders improves performance grade.

It is often advantageous for asphalt to resist flow at high temperatures and/or penetration from physical forces. Various applications including roofing and paving require relatively stable asphalt at high temperatures. For example, paving asphalt should be able to withstand high temperatures encountered in different climates. This ability to withstand high temperatures is conferred by the asphalt’s resistance to flow at high temperatures measured by the softening point of the material (the temperature at which the asphalt achieves a specified degree of viscosity). Asphalts with high softening points are better suited for avoiding damage at higher temperatures.

In addition to resistance to flow, the hardness of an asphalt can be modified for particular applications. A penetration test serves as one metric to measure the hardness of asphalt. Paving asphalt is often made harder to reduce penetration from heavy forces, such as large trucks. Harder asphalts that are stable at high and low temperatures are also less likely to rut and/or crack.

Traditionally oxidation of asphalt is used to modify the softening point and/or hardness of the asphalt. However, the oxidation process is both timely and costly.

Asphalt binders can be used as a bonding coat in applications such as patching, paving and coating to promote adhesion in concrete products and coatings. A common method for determining asphalt binder quality is the Performance Graded System based on the idea that asphalt binder properties should be established by the conditions under which the binder is used. Performance grading uses a set of industry standard tests to measure the physical properties of the asphalt binder that can be directly related to binder performance.

Since asphalt is a thermoplastic material that softens as it is heated, selecting an asphalt binder the has a Performance Grade with a greater high pavement service temperature prevents, or at least reduces, pavement rutting due to traffic and general surface depression. This is particularly important in high temperature climates.

The use of rubbers in asphalt formulations tends to provide a better performing road with increased resilience to traffic and loads. Typical rubbers include fossil and/or virgin styrene butadiene styrene (SBS) rubbers and/or recycled ground tire rubber (GTR). GTR tends to be more cost effective. Additionally, the use of GTR has a positive environmental impact as it recycles waste tires that would otherwise end up in landfills. However, GTR is often not used due to its cross-linked nature which can increase asphalt viscosity and make the asphalt more difficult to process. In addition, the stability of GTR in asphalt can be poor, leading to separation or settling of the rubber.

Waxes can be employed to modify asphalt. One process is disclosed in International Application PCT/CA2017/050172 entitled “Polymer-Modified Asphalt with Wax Additive” which is hereby incorporated by reference. Waxes are compatible with a wide variety of asphalt additives and can be combined with a variety of materials commonly employed to improve the quality of asphalts.

Such waxes can be generated from plastic feedstocks including solid waste. A process to form synthetic waxes from solid waste is discussed in U.S. Pat. No. 8,664,458 “Kumar”. U.S. Pat. No. 8,664,458 and is hereby incorporated by reference.

A method of employing waxes produced from thermal degradation and/or catalytic depolymerization of plastic feedstocks to improve the physical properties of asphalt formulations, reduce emissions of VOCs in asphalt formulations, and/or improve the performance grade of asphalt binders such as paving asphalt and allow for greater incorporation and use of GTR would be commercially advantageous, environmentally responsible and a public health benefit. In some embodiments, these waxes could help adjust the resistance to flow and hardness of the asphalt independent of oxidation. The use of these waxes could reduce, if not eliminate, the need for oxidization.

### SUMMARY OF THE INVENTION

An asphalt formulation can include an asphalt blend and a wax made from polymeric material.

In some embodiments, the wax is made by catalytic depolymerization of the polymeric material. In other embodiments, the wax is made by thermal degradation of the polymeric material.

In certain embodiments, the polymeric material is polypropylene. In some embodiments, the polymeric material is polyethylene. In some embodiments, the polymeric material is polystyrene. In some embodiments, the polymeric material is a mixture of polyethylene, polypropylene, and/or polystyrene. In at least some embodiments, the polymeric material comprises recycled plastics. In some embodiments, the asphalt formulation can include additional modifiers such as ground tire rubber, SBS, and various polymers.

In certain embodiments, the wax is in the range of 0.5% to 25% by weight of the asphalt formulation. In certain embodiments, the wax is in the range of 3% to 5% by weight of the asphalt formulation. In certain embodiments, the wax is in the range of 0.5% to 3% by weight of the asphalt formulation. In certain embodiments, the wax is 5% by weight of the asphalt formulation.

In some embodiments, the wax is a low viscosity polyethylene or polypropylene wax. In other embodiments, the wax is a high viscosity polyethylene or polypropylene wax. Addition of the wax can increase the softening point of the asphalt, decrease the penetration depth of the asphalt and/or reduce, if not eliminate, the amount of time required for asphalt oxidation.

In some embodiments, the asphalt formulation can be made by addition a polyethylene wax to an asphalt blend.

In some embodiments, the wax is in the range of 0.5% to 10% by weight of the asphalt formulation.

Addition of the wax to the asphalt formulation can increase the high service temperature of the asphalt formulation alone or in the presence of other modifiers.

In certain embodiments, the asphalt formulation is a paving asphalt binder.

A method of improving the performance grade of a paving asphalt binder can include adding a polymeric wax to the asphalt binder alone or in the presence of other modifiers.

In some embodiments, a method of manufacturing an asphalt formulation can include adding a wax made from a polymeric material to an asphalt blend. In some embodiments, a method of manufacturing an asphalt formulation can include adding a polyethylene and/or polypropylene wax derived from polymeric feedstock to an asphalt blend.

In some embodiments, a method of improving the properties of an oxidized asphalt can include adding a polyethylene and/or polyethylene wax derived from polymeric feedstock to an oxidized asphalt.

In some embodiments, the asphalt formulation can have a first modifier, a second modifier and a wax, wherein the wax is made from a polymeric material. In some embodiments, the first modifier is ground tire rubber and the second modifier is a polymer.

In some embodiments, the wax is made by catalytic and/or thermal depolymerization of a polymeric material.

In some embodiments, a method of manufacturing an asphalt formulation can include adding a wax made from a polymeric material to an asphalt formulation.

In some embodiments, a method of improving binder performance grade of a paving asphalt binder includes adding a polypropylene wax to the asphalt binder. In some embodiments, a method of improving binder performance grade of a paving asphalt binder can include adding a polypropylene wax and at least one modifier to the asphalt binder, wherein the modifier has a different composition than the wax.

### BRIEF DESCRIPTION OF THE DRAWINGS

FIG. 1 is a bar graph illustrating the softening point of various asphalt formulations.

FIG. 2 is a bar graph illustrating the penetration depth of various asphalt formulations at 25° C.

FIG. 3 is a graph showing the true grade and performance grade high and low service temperatures of various asphalt formulations.

FIG. 4 is a graph showing the results of a Multiple-Stress Creep-Recovery (MSCR) of various asphalt formulations.

FIG. 5 is a graph showing the viscosity of various asphalt formulations at various temperatures.

### DETAILED DESCRIPTION OF ILLUSTRATIVE EMBODIMENT(S)

Various waxes generated from plastic feedstocks can be used to modify asphalt formulations. In some embodiments, the wax is made by catalytic depolymerization of polymeric material. In some embodiments, the wax is made by depolymerizing and/or thermally degrading polymeric material. In some embodiments, the catalyst used is a zeolite or alumina supported system or a combination of the two. In some embodiments, the catalyst is [Fe—Cu—MoP]/Al₂O₃.

In some embodiments, the catalyst is prepared by binding a ferrous-copper complex to an alumina or zeolite support and reacting it with an acid comprising metals and non-metals to obtain the catalyst material. In some embodiments, the catalyst comprises Al, Fe, Cu, and O, prepared by binding ferrous and copper complexes to an alumina and/or zeolite support. Other suitable catalyst materials include, but are not limited to, zeolite, mesoporous silica, H-mordenite and alumina.

In some embodiments, the wax is made by catalytically depolymerizing and/or thermally degrading polymeric material. In some embodiments, depolymerization can occur through the action of free radical initiators or the exposure to radiation.

In some embodiments, the polymeric material is polyethylene. In some embodiments, the polymeric material is polypropylene. In some embodiments, the polymeric material is polystyrene. The polymeric material can be polypropylene (PP), polystyrene (PS), high density polyethylene (HDPE), low density polyethylene (LDPE), linear low density polyethylene (LLDPE), and/or other variations of polyethylene.

In other embodiments, the polymeric material includes both polyethylene and polypropylene material. In some embodiments, the polymeric material is divided evenly by weight between polyethylene and polypropylene. In some embodiments, the polymeric material can contain up to 20% PP, lower levels of polystyrene, polyethylene terephthalate (PET), ethylene-vinyl acetate (EVA), (polyvinyl chloride) PVC, (ethylene vinyl alcohol) EVOH, and undesirable additives and/or contaminants, such as fillers, dyes, metals, various organic and inorganic additives, moisture, food waste, dirt, and/or other contaminating particles.

In other embodiments, the polymeric material includes combinations of LDPE, LLDPE, HDPE, and PP.

In some embodiments, the polymeric material comprises recycled plastics. In other or the same embodiments, the polymeric material comprises recycled plastics and/or virgin plastics.

In some embodiments, the polymeric material includes waste polymeric material feed. Suitable waste polymeric material feeds include mixed polystyrene waste, mixed polyethylene waste, mixed polypropylene waste, and/or a mixture including mixed polyethylene waste and/or mixed polypropylene waste. The mixed polyethylene waste can include LDPE, LLDPE, HDPE, PP, or a mixture including combinations of LDPE, LLDPE, HDPE, and/or PP. In some embodiments, the mixed polyethylene waste can include film bags, milk jugs or pouches, totes, pails, caps, agricultural film, and/or packaging material. In some embodiments, the mixed polypropylene waste can include carpet fibers, bottle caps, yogurt containers, bottle labels. In some embodiments, the mixed polystyrene waste can include food packaging containers, insulation, and electronic packaging. In some embodiments, the waste polymeric material feed includes up to 10% by weight of material other than polymeric material, based on the total weight of the waste polymeric material feed.

In some embodiments, the polymeric material is one of, or a combination of, virgin polyethylene (any one of, or combinations of, HDPE, LDPE, LLDPE and medium-density polyethylene (MDPE)), virgin polypropylene, or post-consumer, or post-industrial, polyethylene and/ or polypropylene (exemplary sources including bags, jugs, bottles, pails, and/or other items containing PE and/or PP).

In some embodiments, the addition of the wax changes the physical characteristics of the asphalt including:
increasing the softening point of asphalt;
decreasing the penetration of the asphalt;
reducing the time required for asphalt oxidation
lowering the formulation viscosity and/or
increasing the stiffness of the asphalt.

In some embodiments, the percentage of wax in the asphalt formulation can be 0.5% to 25% by weight. In some preferred embodiments, the percentage of wax in the asphalt formulation can be 2% to 20% by weight. In some more preferred embodiments, the percentage of wax in the asphalt formulation can be 5% to 15% by weight. In some embodiments, the percentage of wax in the asphalt formulation can be 0.5% to 10% by weight.

In some embodiments, the asphalt formulation can include base asphalt, asphalt extender, asphalt flux, ground tire rubber, styrene-butadiene-styrene (SBS), cross linking agent, fillers, atactic polypropylene (APP), polypropylene, and polyethylene, Styrene Ethylene Butylene Styrene (SEBS), and/or Polyphosphoric Acid (PPA)

In at least some embodiments, the wax is incorporated into asphalt used in roofing asphalts, paving asphalts, asphalt emulsions, cut back asphalts, tack coats, crack fillers, adhesives and other products for waterproofing and joint sealing. In at least some embodiments, the wax can be incorporated into oxidized asphalt such as coating-grade asphalt and mopping-grade asphalt. In other embodiments, the wax can be incorporated into non-oxidized asphalt such as saturant-grade asphalt.

Oxidized asphalt can employ a variety of waxes, including those with melting points between and inclusive of 500-170° C. and viscosities between and inclusive of 10-25,000 cps. In some preferred embodiments, the wax(es) employed have melting points between and inclusive of 60-170° C. and viscosities between and inclusive of 10-10,000 cps. In some more preferred embodiments, the wax(es) employed have melting points between and inclusive of 110-170° C. and viscosities between and inclusive of 10-1000 cps.

Changes in melting point, viscosity, molecular weight, and/or polymer backbone structure of the wax can change the properties of the asphalt mixture. In general, addition of waxes will increase the softening point of the asphalt due to the polymers having higher softening points than the asphalt mixture. In general, addition of waxes will lower viscosities at formulating temperatures.

### Example 1: Addition of Polyethylene Waxes to Mopping Asphalt

In a first example, effects of the addition of a wax formed via depolymerization of polyethylene were observed, As set forth in Tables 1-3, unmodified mopping asphalt served as a control.

TABLE 1

Sample Data Components

| | | |
|---|---|---|
| Ingredient | Grade/Type | Source |
| Asphalt Type IV | Mopping asphalt | Mid-States |
| HV Polyethylene Wax | AW115HV | GreenMantra |
| LV Polyethylene Wax | AW115LV | GreenMantra |

TABLE 2

Asphalt Components as Percentage of Total Weight
Formulation

| | Control I | A | B | C | D |
|---|---|---|---|---|---|
| Asphalt Type IV | 100 | 97 | 95 | 97 | 95 |
| AW115HV | 0 | 3 | 5 | 0 | 0 |
| AW155LV | 0 | 0 | 0 | 3 | 5 |

TABLE 3

Asphalt Properties

| | | Formulation | | | | |
|---|---|---|---|---|---|---|
| | | Control I | A | B | C | D |
| Properties | Softening Point (°C) | 103 | 117 | 124 | 114 | 123 |
| | Penetration at 25° C. (dmm) | 15 | 11 | 11 | 12 | 12 |
| | Viscosity at 75 cps (°C) | 255 | 271 | 278 | 268 | 271 |
| | Flashpoint by Cleveland Open Cup (°C) | 280 | 274 | 266 | 276 | 268 |
| | Ductility (cm) | 3.18 | 2.86 | 1.91 | 2.54 | 1.91 |

Asphalt blends were prepared by mixing oxidized mopping asphalt with AW115HV or AW115LV wax at either 3% or 5% by weight. Mixing was performed by low shear mixers at elevated temperatures.

As set forth in Table 2, Control I Formulation consisted of 100% by weight of mopping asphalt.

Wax Blend Formulation A consisted of 97% by weight of mopping asphalt and 3% by weight of AW115HV.

Wax Blend Formulation B consisted of 95% by weight of mopping asphalt and 5% by weight of AW115HV.

Wax Blend Formulation C consisted of 97% by weight of mopping asphalt and 3% by weight of AW115LV.

Wax Blend Formulation D consisted of 95% by weight of mopping asphalt and 5% by weight of AW115LV.

The softening point of the formulations were determined using ASTM Method D36, the penetration of the formulations were determined using ASTM Method D5, the viscosity of the formulations were determined using ASTM Method D4402, the flashpoint of the formulations were determined using ASTM Method D92, and the ductility of the formulations were determined using ASTM Method D113.

The following conclusions can be drawn from the above test results: addition of 3% or 5% by weight of AW 115LV wax increased the softening point and decreased the penetration depth of the oxidized mopping asphalt compared to Control I. Similarly, addition of 3% or 5% by weight of AW115HV wax increased the softening point of the oxidized mopping asphalt compared to Control I.

More specifically, the addition of AW 115HV wax increased the softening point of the mopping asphalt by 12% or 18% and decreased the penetration depth of the mopping asphalt by 27%.

The addition of AW115LV wax increased the softening point of the mopping asphalt by 10% or 18% and decreased the penetration depth of the mopping asphalt by 20%.

Increasing the softening point and decreasing the penetration depth of oxidized mopping asphalt provides the following benefits:
reducing the time required for asphalt oxidation;
increasing the asphalt resistance to flow at high temperatures;
improving the hardness properties of the asphalt;
allowing for greater control of tailoring the physical properties of the asphalt; and
handling variations in the supply stream.

Reduced asphalt oxidation time can be advantageous as it lowers production costs and/or emissions and allows material to be manufactured in a shorter amount of time.

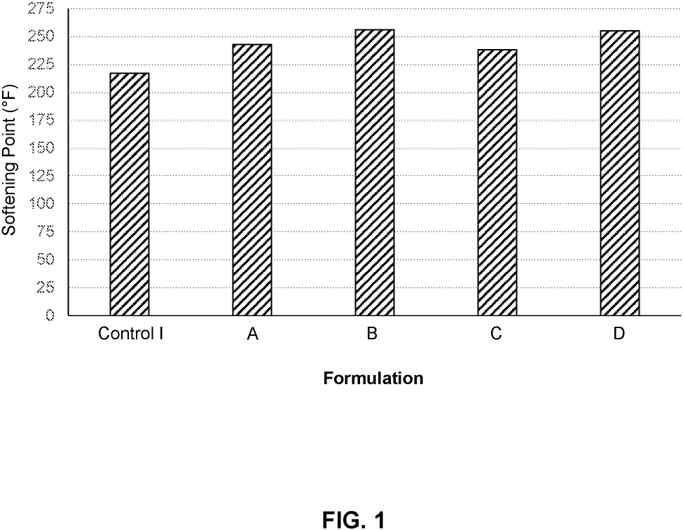

FIG. 1 is a bar graph illustrating the softening point of various asphalt formulations. Softening points were measured according to ASTM D36 standards.

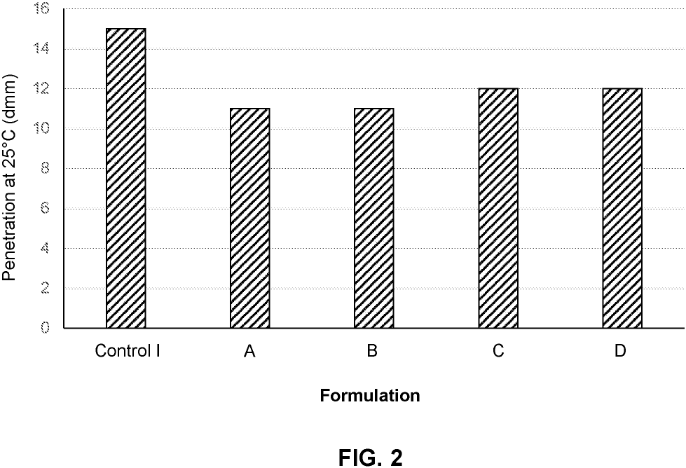

FIG. 2 is a bar graph illustrating the penetration depth of various asphalt formulations at 25° C. Penetration was measured according to ASTM D5 standards.

In some embodiments, the percentage of wax in the asphalt formulation, blend, or flux is 5% percent by weight. In some embodiments, the percentage of wax in the asphalt formulation, blend, or flux is between and inclusive of 0.5% to 15% percent by weight. In some embodiments, the percentage of wax in the asphalt formulation, blend, or flux is between and inclusive of 0.5% to 10% percent by weight.

In some embodiments, the asphalt formulation can include base asphalt, asphalt extender, asphalt flux, styrene-butadiene-styrene (SBS), cross linking agent and/or fillers.

In at least some embodiments, the wax is incorporated into an asphalt flux that can be used in roofing asphalts, paving asphalts, crack fillers, adhesives and/or other products for waterproofing and joint sealing. In at least some embodiments, the wax can be incorporated into oxidized asphalt such as coating-grade asphalt and mopping-grade asphalt. In other embodiments, the wax can be incorporated into non-oxidized asphalt such as saturant-grade asphalt.

Asphalt flux and various asphalt formulations can employ a variety of waxes, including those with melting points between and inclusive of 100-170° C. and viscosities between and inclusive of 10-5000cps.

Changes to the wax, including but not limited to its molecular weight, and/or polymer backbone structure, can change the properties of the asphalt mixture.

Other potential benefits include increasing the shelf life of an asphalt formulation and extending the lifespan of roofing and coating materials that use a wax-modified asphalt formulation.

In some embodiments, waxes can be used in asphalt binders to increase performance grade. Such modifications can make the asphalt more stable at higher temperatures. Wax-modified asphalt binders can be used in applications such as patching, paving and coating.

In some embodiments, the addition of the wax improves the performance grade of an asphalt binder alone or in conjunction with other modifiers/additives by increasing the high service temperature. In certain embodiments, the modifiers can be ground tire rubber and various polymers. Increasing the high service temperature of asphalt provides the following benefits:
increasing asphalt stability at higher temperatures, making it better suited for use in hot climates;
preventing softening and deformation of pavement due to traffic; and/or lowering manufacturing costs.

In some embodiments the wax allows for GTR to be used with or as a replacement of SBS, offsetting it by 1-100%, without negatively affecting the asphalt formulation.

### Example 2: Addition of Polypropylene Wax to Asphalt Binder

In at least some embodiments, the wax is incorporated into asphalt used in paving asphalts, crack fillers, adhesives and other products for waterproofing and joint sealing. In at least some embodiments, the wax can be incorporated into oxidized asphalt such as coating-grade asphalt and mopping-grade asphalt. In other embodiments, the wax can be incorporated into non-oxidized asphalt such as saturant-grade asphalt.

In some embodiments, waxes can be used to modify paving asphalt binder. Paving asphalt binder can employ a variety of waxes, including those with melt points between and inclusive of 60-170° C., and viscosities between and inclusive of 5-3000cps. In some preferred embodiments, the wax(es) employed have melt points between and inclusive of 110-170° C. and/or viscosities between, and including, 15-1000 cps.

In some preferred embodiments, a polypropylene wax can be used to improve performance grade of paving asphalt binder.

Changes in melting point, viscosity, molecular weight, and/or polymer backbone structure of the wax can change the properties of the asphalt mixture.

TABLE 4

Sample Data Components

| | | |
|---|---|---|
| Ingredient | Grade/Type | Source |
| Asphalt Binder | Paving Grade Asphalt (PG58-28) | Commercial Stock |
| Asphalt Modifier | Ground Tire Rubber | Commercial Stock |
| Asphalt Modifier | Polymer | Commercial Stock |
| Polypropylene Wax | A155 wax | GreenMantra (Applicant) |

TABLE 5

Asphalt Components as Percentage of Total Weight
Formulation

| | Control II | E | F | G | H |
|---|---|---|---|---|---|
| PG58-28 | 100 | 99.5 | 97 | 86.5 | 84 |
| Ground Tire Rubber | 0 | 0 | 0 | 10 | 10 |
| Polymer | 0 | 0 | 0 | 3 | 3 |
| A155 wax | 0 | 0.5 | 3 | 0.5 | 3 |

Asphalt formulations were prepared by mixing asphalt binder with various modifiers including ground tire rubber (GTR), polymer, and/or A155 wax.

As set forth in Table 5, Control II consisted of unmodified asphalt binder.

Asphalt Formulation E consisted of 99.5% by weight of asphalt binder and 0.5% by weight of A155 wax.

Asphalt Formulation F consisted of 97% by weight of asphalt binder and 3% by weight of A155 wax.

Asphalt Formulation G consisted of 86.5% by weight of asphalt binder, 10% by weight of GTR, 3% by weight of polymer and 0.5% by weight of A155 wax.

Asphalt Formulation H consisted of 84% by weight of asphalt binder, 10% by weight of GTR, 3% by weight of polymer and 3% by weight of A155 wax.

Binder testing to measure true grade of the paving asphalt formulations included the Rotational Viscometer Test, the Dynamic Shear Rheometer test, the Bending Beam Rheometer test and the Direct Tension Test.

TABLE 6

True Grade and Performance Grade of Formulations
Formulation

| | Control II | | E | | F | | G | | H | |
|---|---|---|---|---|---|---|---|---|---|---|
| | High | Low | High | Low | High | Low | High | Low | High | Low |
| True Grade (°C) | 60.8 | -28.7 | 61.6 | -28.2 | 66.5 | -20 | 82.6 | -26.3 | 91.5 | -25.8 |
| Performance Grade (°C) | 58 | -28 | 58 | -28 | 64 | -16 | 82 | -22 | 88 | -22 |

As can be seen above, the addition of A155 wax improved the performance of the asphalt binder at high temperatures alone and in conjunction with other modifiers including GTR and polymer. This change can be seen by comparing the Performance Grade high service temperature of each formulation with the upper temperature reported from binder testing of each formulation (reported as true grade values).

The ability of A155 wax to improve the high service temperature of asphalt binder in the presence of GTR and polymer indicates that the A155 wax facilitates incorporation of asphalt modifiers. This is advantageous because it can lower the production cost associated with mixing GTR into paving asphalt, a process that requires greater high shear mixing when compared to SBS for incorporation into asphalt.

Alternatively, production cost could be lowered by adding the A155 wax and a lower amount of GTR to the asphalt binder without compromising the performance grade of the final paving asphalt product. This can produce an asphalt formulation with a much lower viscosity that flows faster and is easier to process.

Turning first to the results for Control II, unmodified asphalt binder had a true grade temperatures of 60.8° C. and -28.7° C. Addition of A155 wax at 0.5% by weight (Formulation E) or 3% by weight (Formulation F) to the asphalt binder increased the true grade high service temperature by 0.8° C. and 5.7° C., respectively, compared to the true grade high service temperature of Control II. 0.5% of A155 wax increased the high service temperature to 61.6° C. which is 3.6 degrees greater than the performance grade high service temperature of 58° C. for the same formulation. 3% of A155 wax increased the high service temperature to 66.5° C. which is 2.5 degrees greater than the performance grade high service temperature of 64° C. for the same formulation. These data demonstrate that the A155 wax directly affects and improves asphalt binder performance at high temperatures.

Comparing Control II with the addition of both the wax and the GTR led to even greater results. Addition of GTR at 10% by weight, polymer at 3% by weight, and A155 wax at 0.5% by weight (Formulation G) or GTR at 10% by weight, polymer at 3% by weight, and A155 wax at 3% by weight (Formulation H) increased the true grade high service temperature by 21.8° C. and 30.7° C., respectively, compared to the true grade high service temperature of Control II. 0.5% of A155 wax increased the high service temperature to 82.6° C. which is 0.6 degrees greater than the performance grade high service temperature of 82° C. for the same formulation. 3% of A155 wax increased the high service temperature to 91.5° C. which is 3.5 degrees greater than the performance grade high service temperature of 88° C. for the same formulation. These data points demonstrate that the A155 wax enhances the ability of other asphalt modifiers, GTR and a polymer in this instance, to improve asphalt binder performance at high temperatures.

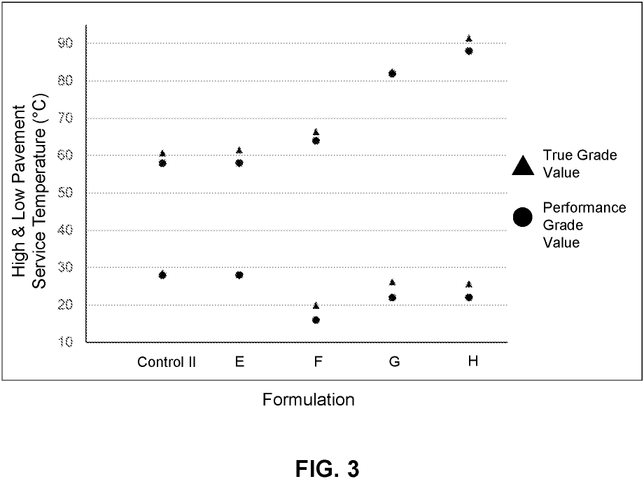

FIG. 3 is a graph showing the true grade and performance grade high and low service temperatures of various asphalt formulations.

Increasing the high service temperature of asphalt, as well as addition of GTR, can provide at least one, if not all, of the following benefits:
increasing asphalt stability at higher temperatures, making it better suited for use in hot climates;
preventing softening and deformation of pavement due to traffic;
increasing road elasticity or recovery under various weather and/or load-related stresses;
lowering the formulation cost compared to use of SBS; and/or
reducing the amount of GTR in landfills.

### Example 3: Addition of Wax to Asphalt Binder

TABLE 7

Sample Data Components

| | | |
|---|---|---|
| Ingredient | Grade/Type | Source |
| Asphalt Binder | Paving Grade Asphalt (PG64-22) | Commercial Stock |
| Polyethylene Wax | A115 wax | GreenMantra (Applicant) |
| Polyethylene Wax | A120 wax | GreenMantra (Applicant) |
| Polyethylene Wax | A125 wax | GreenMantra (Applicant) |
| Polypropylene Wax | A155 wax | GreenMantra (Applicant) |

TABLE 8

Asphalt Components as Percentage of Total Weight
Formulation

| | Control III | I | J | K | L |
|---|---|---|---|---|---|
| PG64-22 | 100 | 97 | 97 | 97 | 97 |
| A115 wax | 0 | 3 | 0 | 0 | 0 |
| A120 wax | 0 | 0 | 3 | 0 | 0 |
| A125 wax | 0 | 0 | 0 | 3 | 0 |
| A155 wax | 0 | 0 | 0 | 0 | 3 |

Asphalt formulations were prepared by mixing asphalt binder with the various waxes.

As set forth in Table 8, Control II consisted of an unmodified asphalt binder.

Asphalt Formulation I consisted of 97% by weight of asphalt binder and 3% by weight of A115 wax.

Asphalt Formulation J consisted of 97% by weight of asphalt binder and 3% by weight of A120 wax.

Asphalt Formulation K consisted of 97% by weight of asphalt binder and 3% by weight of A125 wax.

Asphalt Formulation L consisted of 97% by weight of asphalt binder and 3% by weight of A155 wax.

Binder testing to measure true grade of the paving asphalt formulations included the Rotational Viscometer Test, the Dynamic Shear Rheometer test, the Bending Beam Rheometer test and the Direct Tension Test.

TABLE 9

True Grade and Performance Grade of Formulations
Formulation

| | Control III | | I | | J | | K | | L | |
|---|---|---|---|---|---|---|---|---|---|---|
| | High | Low | High | Low | High | Low | High | Low | High | Low |
| True Grade (°C) | 69.3 | -24.0 | 74.6 | -21.1 | 72.2 | -20.1 | 75.6 | -21.5 | 79.2 | -22.7 |
| Performance Grade (°C) | 64 | -22 | 70 | -16 | 70 | -16 | 70 | -16 | 76 | -22 |

As can be seen above, the addition of waxes improved the performance of the asphalt binder at high temperatures. This change can be seen by comparing the Performance Grade high service temperature of each formulation with the upper temperature reported from binder testing of each formulation (reported as true grade values).

The addition of the polypropylene wax (Formulation L) had the greatest effect on the Performance Grade high service temperature. This is due to the higher softening point of the wax which in turn increases the softening point of the asphalt, leading to a stiffer asphalt at the temperatures included in the testing.

Increasing the high service temperature of asphalt can provide at least one, if not all, of the following benefits:
increasing asphalt stability at higher temperatures, making it better suited for use in hot climates;
preventing softening and deformation of pavement due to traffic;
increasing road elasticity or recovery under various weather and/or load-related stresses; and/or
lowering the formulation cost compared to use of SBS.

The ability of the waxes to improve the high service temperature of asphalt binder waxes facilitate incorporation of asphalt modifiers.

TABLE 10

Multiple-Stress Creep-Recovery of Formulations
Formulation

| | Control III | I | J | K | L |
|---|---|---|---|---|---|
| 0.1- Rolling Thin-Film Oven | 1.650 | 0.600 | 1.100 | 0.565 | 0.175 |
| 3.2- Rolling Thin-Film Oven | 1.750 | 1.000 | 1.300 | 0.860 | 0.645 |

Non-recoverable creep compliances of the formulations were measured at two different stress levels (0.1 and 3.2). Results are shown in kPa⁻¹. In determining traffic rating, AASHTO M332 uses the 3.2 stress level, and the cutoffs are ≤2.0 for heavy traffic (H) and ≤1.0 for Very Heavy traffic (V). In this case both K and L showed noted benefits.

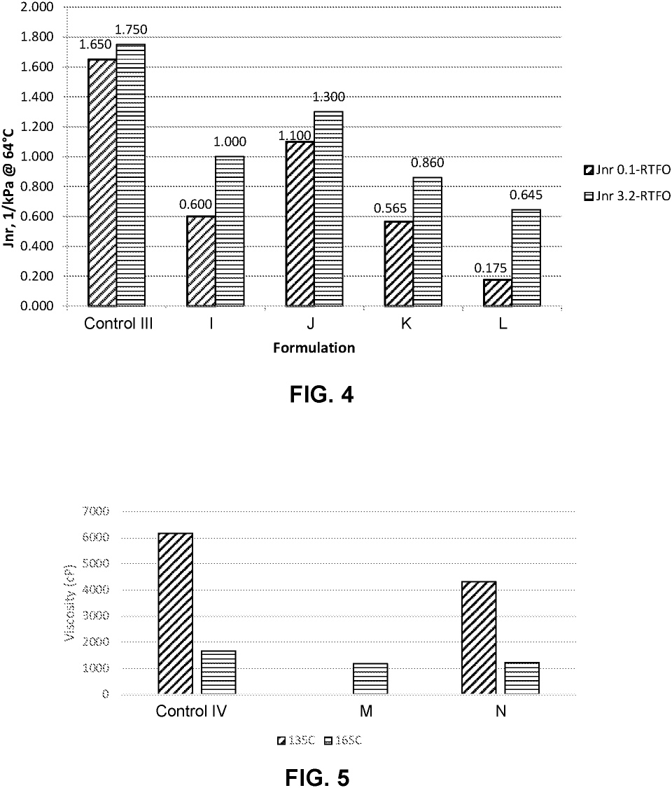

FIG. 4 is a graph showing the results of a Multiple-Stress Creep-Recovery (MSCR) of various asphalt formulations.

The MSCR was conducted according to AASHTO M332. As seen in Table 10 and FIG. 4, an improvement in non-recoverable creep compliance (Jₙᵣ) was seen in each Formulation incorporating a wax. This indicates an increase in rut resistance and the ability to handle heavier traffic loads. For Formulation L, an improvement of the traffic designation of the MSCR based performance grade with a possible increase from 64H-22 to 64V-22 was observed

### Example 4 - Displacement of SBS in SBS Modified Asphalt

TABLE 11

Sample Data Components

| | | |
|---|---|---|
| Ingredient | Grade/Type | Source |
| Asphalt Binder | Paving Grade Asphalt (PG64-22) | Commercial Stock |
| Asphalt Modifier | SBS | Commercial Stock |
| Polyethylene Wax | A115 wax | GreenMantra (Applicant) |
| Polypropylene Wax | A155 wax | GreenMantra (Applicant) |

TABLE 12

Asphalt Components as Percentage of Total Weight
Formulation

| | Control IV | M | N |
|---|---|---|---|
| PG64-22 | 97 | 97 | 97 |
| SBS | 3 | 2 | 2 |
| A115 wax | 0 | 0 | 1 |
| A155 wax | 0 | 1 | 0 |

TABLE 13

True Grade and Performance Grade of Formulations
Formulation

| | Control IV | | M | | N | |
|---|---|---|---|---|---|---|
| | High | Low | High | Low | High | Low |
| True Grade (℃) | 79.9 | -8.3 | 79.9 | -11.0 | 78.7 | -6.6 |

Table 13 shows an improvement of the true grade in the high temperature range, modifying a binder containing SBS by offsetting with waxes. This shows an improvement in decreasing deformation, and increased stability at high temperatures.

TABLE 14

Viscosity Measurements of Formulations
Formulation

| | Control IV | M | N |
|---|---|---|---|
| cP at 135° C. | 6168.75 | Still semisolid | 4312.5 |
| cP at 165° C. | 1668.75 | 1175 | 1225 |

FIG. 5 is a graph showing the viscosity of various asphalt formulations at various temperatures. FIG. 5 illustrates the lowering of the viscosity of an SBS modified binder by offsetting SBS with waxes. This reduction in viscosity indicates the ability to facilitate incorporation of other modifiers.

Binder testing followed AASHTO M320 and M322 for performance grade and included rotational viscosity testing, dynamic shear rheometry, bending beam rheometry, and aging methods including a rolling thin film oven test, and pressure aging vessel. The true grade was determined from the data obtained by these tests.

While particular elements, embodiments and applications of the present invention have been shown and described, it will be understood, that the invention is not limited thereto since modifications can be made without departing from the scope of the present disclosure, particularly in light of the foregoing teachings.

What is claimed is:

1. A paving asphalt formulation comprising:
an asphalt;
a depolymerized wax;
an amount of polyphosphoric acid; and
a first modifier
wherein said depolymerized wax is made via a polymeric material undergoing a catalytic depolymerization process,
wherein said catalytic depolymerization process utilizes a catalyst, and
wherein said polymeric material comprises recycled plastics and an at least one contaminant, wherein said contaminant is a filler, a dye, or a metal.

2. The paving asphalt formulation of claim 1 wherein said catalyst is prepared by binding a ferrous-copper complex to an alumina or zeolite support and reacting said ferrous-copper complex and an alumina support or a zeolite support with an acid comprising metals and non-metals to obtain the catalyst.

3. The paving asphalt formulation of claim 1 wherein said polymeric material is polyethylene.

4. The paving asphalt formulation of claim 1 wherein said polymeric material is polypropylene.

5. The paving asphalt formulation of claim 1 wherein said paving asphalt formulation further comprises:
an asphalt extender.

6. The paving asphalt formulation of claim 1 wherein said polymeric material is polystyrene.

7. The paving asphalt formulation of claim 1 wherein said catalyst is [Fe—Cu—Mo—P]/Al₂O₃.

8. The paving asphalt formulation of claim 1 wherein said depolymerized wax is in the range of .5% to 3% by weight of said paving asphalt formulation.

9. The paving asphalt formulation of claim 1 wherein said asphalt is a mopping asphalt.

10. The paving asphalt formulation of claim 1 wherein said asphalt is a saturant-grade asphalt.

11. The paving asphalt formulation of claim 1 further comprising:
an asphalt extender;
asphalt flux;
a ground tire rubber,
styrene-butadiene- styrene;
a cross linking agent;
an amount of atactic polypropylene;
an amount of styrene-ethylene-butylene-styrene, and
an amount of a polyphosphoric acid.

12. The paving asphalt formulation of claim 1 wherein said depolymerized wax has a melting point between 110° C. -170° C.

13. The paving asphalt formulation of claim 1 wherein said paving asphalt formulation includes styrene-butadiene-styrene.

14. The paving asphalt formulation of claim 1 wherein said depolymerized wax is in the range of 5% to 15% by weight of said paving asphalt formulation.

15. The paving asphalt formulation of claim 2 wherein said first modifier is a ground tire rubber.

16. The paving asphalt formulation of claim 2 further comprising:
a second modifier.

17. The paving asphalt formulation of claim 3 wherein said depolymerized wax a A115 wax, a A120 wax, and/or a A125 wax.

18. The paving asphalt formulation of claim 4 wherein said depolymerized wax a A155 wax.

19. A method of reducing the time required for asphalt oxidation of a paving asphalt formulation comprising:
adding an amount of a depolymerized wax to said paving asphalt formulation, wherein said paving asphalt formulation comprises:
an asphalt;
an amount of polyphosphoric acid; and
a first modifier
wherein said depolymerized wax is made via a polymeric material undergoing a catalytic depolymerization process,
wherein said catalytic depolymerization process utilizes a catalyst, and
wherein said polymeric material comprises recycled plastics and an at least one contaminant, wherein said contaminant is a filler, a dye, or a metal.

20. A method of increasing the stability of a paving asphalt formulation comprising:
adding an amount of a depolymerized wax to said asphalt paving asphalt formulation.
